(19) United States
(12) Patent Application Publication
(10) Pub. No.: US 2025/0229297 A1
(43) Pub. Date: Jul. 17, 2025

(54) REMAINING HAND SORTING DEVICE AND METHOD FOR SORTING REMAINING HAND MAIL ITEMS

(71) Applicant: Korber Supply Chain Logistics GmbH, Konstanz (DE)

(72) Inventors: Dirk-Udo Eisser, Reichenau (DE); Rainer Vogel, Konstanz (DE)

(21) Appl. No.: 19/021,844

(22) Filed: Jan. 15, 2025

(30) Foreign Application Priority Data
Jan. 15, 2024 (DE) 10 2024 101 042.8

(51) Int. Cl. B07C 3/00

(52) U.S. Cl. CPC B07C 3/003

(57) ABSTRACT

A residual hand sorting device for sorting residual hand mail items is provided that includes an infeed conveyor configured to convey at least one residual hand mail item in a first direction, at least one distribution conveyor configured to take over the at least one residual hand mail item from the infeed conveyor and to convey it to at least one output conveyor, and a control unit configured to control the distribution conveyor and/or the output conveyor such that residual hand mail items are collected on the output conveyor in a collection arrangement, wherein the output conveyor is configured to convey the collection arrangement of residual hand mail items in a second direction, and a related method.

### BACKGROUND

The present disclosure relates to a residual hand sorting device for sorting residual hand mail items and a method for sorting residual hand mail items.

Nowadays, there are various sorting solutions for letter and parcel logistics. They essentially differ in terms of their specialization for a specific range of items, the range of functions, the sorting depth and the throughput. For example, there are letter and large letter distribution systems, systems for the distribution of small parcels and parcels. In all of these systems, mail items may occur that cannot be sorted due to their physical properties and/or non-readability of the address. Such items are referred to as residual hand mail items, residual hand piece goods or residual hand mail items. These mail items are ejected from the automated sorting process and sent to what is known as residual hand sorting. There, the mail items have to be sorted by hand, which requires a lot of manpower and is associated with high costs.

Therefore, it is an object of the present disclosure to simplify a residual hand sorting.

### SUMMARY OF THE INVENTION

According to one aspect of the present disclosure, a residual hand sorting device for sorting residual hand mail items is provided. The residual hand sorting device may comprise an infeed conveyor configured to convey at least one residual hand mail item in a first direction. Furthermore, the residual hand sorting device can comprise at least one distribution conveyor, which is designed to take over the at least one residual hand mail item from the infeed conveyor and convey it to at least one output conveyor. Furthermore, the residual hand sorting device can comprise a control unit which is designed to control the distribution conveyor and/or the output conveyor in such a way that residual hand mail items are collected on the output conveyor in a collection arrangement. The output conveyor can be designed to convey the collection arrangement of residual hand mail items in a second direction.

Compared to the known prior art, the object of the present disclosure provides the advantage that automated sorting of residual hand mail items with a large range of items is possible with a simple sorting system. Furthermore, a number of mailing entries and end points can be freely configured in the above residual hand sorting device. The collection arrangement can be used to save space when storing and providing the sorted residual hand mail items on the output conveyor. Furthermore, the collection arrangement on the output conveyor makes it possible to manually remove the residual hand mail items from there and process them further by means of manual distribution according to the first-in-first-out principle, for example in a throwing circle. In other words, the residual hand mail items cannot be mixed or randomly provided on the output conveyor (as would be the case, for example, with a bin or container in a conventional end point), but in the order in which the residual hand mail items were fed to the output conveyor. In addition or alternatively, the collection arrangement on the output conveyor makes it possible to deposit the residual hand mail items collected there in containers in the collection arrangement and to transport them further (i.e. while retaining the collection arrangement). In addition, the manual residual mail sorting device offers the option of feeding selected residual hand mail items to a special destination. The residual hand sorting device is also suitable for a wide range of residual hand mail items, for example from a postcard to a small parcel, in particular with a thickness of up to 150 mm. The collection arrangement on the output conveyor means that a large quantity of residual hand mail items can be stored in the output conveyor before they need to be removed. This can improve work processes and increase efficiency. Furthermore, a sorting sequence of the residual hand mail items can be maintained by the collection arrangement. Furthermore, by arranging the residual hand mail items of the collection arrangement on the output conveyor, the user can decide how many residual hand mail items are to be removed from the output conveyor. In addition, containers can be filled with the residual hand mail items in the collection arrangement while maintaining the sorting sequence. Therefore, with the subject-matter of the present disclosure, a significant increase in efficiency can be achieved compared to a previously known manual sorting of residual hand mail. In particular, the subject-matter of the present disclosure does not require highly trained employees to carefully carry out a manual sorting of remnants. Rather, it is sufficient to feed the residual hand mail items to the residual hand sorting device in a specific manner and then remove the sorted residual hand mail items which have been delivered to the collection arrangement, without having to observe a sequence of the residual hand mail items.

Residual hand mail items can be items, mail pieces or postal items that are not accessible for machine processing. This may be due to the characteristics of the respective mail item or due to incomplete address details or illegibility. Such mail items are ejected from the automated handling process and sent for so-called residual hand sorting. This can also involve particularly bulky or non-machine-compatible mail items, for example. A mail item can be a postcard, envelope, mailing bag, packet, small package, parcel, transport roll, polybag or similar. The residual hand mail items must also be sorted according to certain sorting criteria, for example the zip code, in order to be processed accordingly. The mail items ejected from the automated process in this way are fed to the residual hand sorting system and then designated as residual hand mail items. The residual hand mail items can be placed on an infeed conveyor. The application of the residual hand mail items to the infeed conveyor can be done in such a way that the address is recognizable for a recognition system arranged on the infeed conveyor. For example, the at least one residual hand mail item can be placed on the infeed conveyor with the address facing upwards. This can simplify the recognition process, as the position of the address information on the residual hand mail item is known. The infeed conveyor can be a conveyor belt that is designed to transport the residual hand mail items. However, the infeed conveyor can also be a roller conveyor, ball conveyor or other conveyor device that can transport residual hand mail items in the first direction. The infeed conveyor can convey at least one residual hand mail item in the first direction. From the infeed conveyor, the at least one residual hand mail item can be transferred to a distribution conveyor. The distribution conveyor can be designed to distribute the residual hand mail item. In other words, the distribution conveyor can actively and individually distribute a mail item to a specific destination. Like the infeed conveyor, the distribution conveyor can be designed as a belt conveyor element, roller conveyor, ball conveyor and the like. The distribution conveyor can be actively controlled in order to distribute the residual hand mail item. The residual hand mail item can be passively or actively transferred from the infeed conveyor to the distribution conveyor. From the distribution conveyor, the residual hand mail item can be actively (e.g. controlled) transferred to an output conveyor. In other words, the distribution conveyor can feed the at least one residual hand mail item to the output conveyor. The residual hand device may comprise a control unit that can control the operation of the residual hand sorting device. The control unit can be a computer-like device that can receive information, process information and output information. The control unit can therefore receive input information, carry out internal processing and issue control commands as output information. For example, the control unit can control the distribution conveyor in order to determine when the distribution conveyor feeds a residual hand mail item on it to which destination. Like the distribution conveyor and/or the infeed conveyor, the output conveyor can be a belt conveyor, roller conveyor, ball conveyor or the like. The control unit can also control the output conveyor in order to actively drive it. The distribution conveyor can therefore feed a residual hand mail item to at least one output conveyor based on a control system of the control unit. In this case, the residual hand mail item can be arranged on the output conveyor in such a way that the at least one residual hand mail item is arranged in a collection arrangement. A collection arrangement can be understood to mean a specific orientation and/or position of a residual hand mail item. Furthermore, a collection arrangement can also define a specific relative positioning of several residual hand mail items on the output conveyor in relation to one another. For example, if there is already a residual hand mail item on the output conveyor and the distribution conveyor is to feed a further residual hand mail item on the output conveyor, the control unit can control either the distribution conveyor alone or the distribution conveyor and the output conveyor together in order to achieve a desired collection arrangement. For example, the control unit can be designed to achieve a relative positioning of two residual hand mail items on the output conveyor. Furthermore, the output conveyor can be designed to collect residual hand mail items. In other words, the output conveyor can serve as an intermediate storage unit before the residual hand mail items are processed further. This can simplify the processes involved in handling the residual hand mail items and increase their efficiency. The collection arrangement can also provide the residual hand mail items in the sequence in which they were fed to the output conveyor. In this way, a sequence of the residual hand mail items can be maintained (first-in first-out principle). Furthermore, the output conveyor can be designed to convey the collection arrangement in the second direction. In other words, the output conveyor can not only be a collection point, but can be controlled by the control unit in such a way that the formed collection arrangement is transported further. This can ensure that the collection arrangement, which can be a specific arrangement of residual hand mail items relative to one another, can also be realized for a plurality of residual hand mail items on the output conveyor. In other words, by removing the first residual hand mail items which are placed on the output conveyor, new space can be created again and again in order to arrange further residual hand mail items in the collection arrangement on the output conveyor. In this way, a large number of residual hand mail items can be provided in the desired collection arrangement on the output conveyor.

Optionally, at least two residual hand mail items overlap at least partially in the collection arrangement. In other words, the control unit can control the distribution conveyor and/or the output conveyor in such a way that a second residual hand mail item, which is placed on the output conveyor after a first residual hand mail item, comes to rest at least partially on the first residual hand mail item. As a result, the number of residual hand mail items that can be arranged on the output conveyor can be increased. As a result, the storage capacity of the output conveyor can be increased. Due to the partial overlapping, the order in which the residual hand mail items have been deposited can be maintained.

Optionally, the distribution conveyor is designed to receive several residual hand mail items. In other words, the distribution conveyor can be used to collect a large number of residual hand mail items before the residual hand mail items are delivered to the output conveyor. Optionally, the distribution conveyor is designed to collect the plurality of residual hand mail items in a stacked manner, at least in sections. This can be achieved by moving the distribution conveyor step by step after picking up a residual hand mail item. As a result, a collection arrangement can already be formed on the distribution conveyor. The collection arrangement created in this way on the distribution conveyor can then be fed to the output conveyor all at once. Furthermore, a certain number of residual hand mail items can be placed on top of each other on the distribution conveyor, i.e. stacked, in particular after being ejected by the conveyor module. When a certain stack height has been reached on the distribution conveyor, or the sorting plan allows the stacked residual hand mail items to be removed, they are fed to the output conveyor. In other words, the stacked residual hand mail items are either transported in the collection arrangement on the output conveyors or treated as a non-shingled residual hand mail item. This can further increase the throughput of the system, e.g. for two consecutive residual hand mail items with the same sorting destination. Furthermore, a larger number of residual hand mail items can be stored in the sorting end point or on the output conveyors.

Optionally, the control unit is designed to control the distribution conveyor and/or the output conveyor in such a way that a residual hand mail item, which is applied to the output conveyor first, protrudes further in the second direction, at least in sections, than a residual hand mail item subsequently applied to the output conveyor. In other words, at least two residual hand mail items arranged on the output conveyor can overlap in such a way that the piece good first applied to the output conveyor is still recognizable. In other words, the mail item placed first on the output conveyor is arranged further forward in the second direction (i.e. in the conveying direction of the output conveyor). In this way, the sorting sequence can be maintained even with a large number of residual hand mail items arranged in the collection arrangement on the output conveyor.

Optionally, the first direction and the second direction are aligned at an angle to one another. In other words, the second direction, in which the output conveyor conveys the residual hand mail items, can be arranged at a different height position relative to the first direction, in which the infeed conveyor conveys the at least one residual hand mail item. This can simplify the transfer from the infeed conveyor to the output conveyor. Furthermore, a compact overall system can be realized.

Optionally, the first direction lies in a first plane, wherein the second direction may lie in a second plane and wherein the first plane and the second plane may be spaced apart. In other words, the output conveyor and the infeed conveyor can be arranged at different height positions. This can provide a particularly space-saving residual hand sorting device.

Optionally, the residual hand mail items in the collection arrangement are arranged in a shingle-like manner, at least in sections. A shingle-like arrangement can be an arrangement in which the residual hand mail items at least partially overlap. In this case, the overlap of adjacent pairs of residual hand mail items can always be similar. In this way, a homogeneous collection arrangement can be realized on the output conveyor.

Optionally, the residual hand mail items in the collection arrangement on the output conveyor are conveyed at least in sections in an imbricated stream in the second direction. In other words, the shingled stream (i.e. the collection arrangement of residual hand mail items) can be conveyed in a constant arrangement in the second direction on the output conveyor. As a result, a storage capacity of the output conveyor can be increased without changing a sequence of the residual hand mail items.

Optionally, the control unit is designed to control the distribution conveyor and/or the output conveyor based on at least one piece of information about the at least one residual hand mail item in such a way that the residual hand mail item is arranged on the output conveyor in the collection arrangement. The control unit can, for example, obtain information about the residual hand mail item to be handled or the residual hand mail item to be sorted. The at least one piece of information may, for example, be a dimension of the residual hand mail item. By knowing the dimension of the residual hand mail item, the control unit can control the output conveyor and/or the distribution conveyor in such a way that the residual hand mail item transferred from the distribution conveyor to the output conveyor is positioned in a desired manner. This is particularly advantageous if there are a large number of differently dimensioned residual hand mail items. As a result, a collection arrangement can be realized in a similar way regardless of the dimensions of the respective residual hand mail item.

Optionally, the distribution conveyor is designed to convey the at least one residual hand mail item either to a first output conveyor or to a second output conveyor. In other words, the distribution conveyor can be designed to convey a mail item located thereon in two different directions. Optionally, the distribution conveyor is designed to be drivable in two different directions. Optionally, the two directions are opposite to each other. For example, the distribution conveyor is a belt conveyor that can be driven in either one direction or the other. Thus, the distribution conveyor can convey a residual hand mail item either in one direction or in an opposite other direction. As a result, the residual hand sorting device can be more compact overall. Furthermore, the possible destinations of the residual hand mail items can be increased without the system requiring a significantly larger surface area. Optionally, the second output conveyor is arranged adjacent to the distribution conveyor in a direction opposite to the second direction.

Optionally, the distribution conveyor is arranged in a third plane, wherein the third plane is spaced at least in sections from the first plane and/or from the second plane. Optionally, the distribution conveyor can be arranged between the first plane and the second plane. The third plane, in which the distribution conveyor can be arranged, can be a plane in which the surface of the distribution conveyor is located. The surface of the distribution conveyor can be defined by a contact surface between the distribution conveyor and a residual hand mail item applied to it. Optionally, a residual hand mail item can therefore be conveyed from the first level onto the distribution conveyor and further conveyed from the distribution conveyor to the second level. This means that the residual hand mail item can always be conveyed downwards in the direction of gravity as it passes through the residual hand sorting device. This enables efficient handling of the residual hand mail item, as it does not have to be moved against the direction of gravity.

Optionally, the distribution conveyor is inclined with respect to the infeed conveyor and/or the output conveyor. The inclination of the distribution conveyor can ensure that a residual hand mail item always comes to rest at the same position on the distribution conveyor (e.g. regardless of the size of the residual hand mail item). Therefore, an initial situation can be known from which a residual hand mail item is conveyed further from the distribution conveyor to the output conveyor, so that the control unit can easily realize the collection arrangement on the output conveyor. In other words, by inclining the distribution conveyor, gravity can be used to bring a residual hand mail item fed from the infeed conveyor into a predetermined position.

Optionally, the distribution conveyor has an inclination to the horizontal in a range of 8° to 12°, preferably about 10°. In the range of 8° to 12°, it has been shown that it is sufficient for the usual mail items to overcome the friction between the mail item and the distribution conveyor surface and to reach the predetermined position on the distribution conveyor. If a large quantity of foil-wrapped residual hand mail items is to be distributed, it has been found that an inclination of the distribution conveyor of approximately 10° is preferable. If the inclination is steeper, the low friction between the bag-like residual hand mail items and the surface of the distribution conveyor can result in high transport speeds, which means that a smaller and lighter residual hand mail item runs the risk of falling off the distribution conveyor.

Optionally, the distribution conveyor has a guide element that is designed to guide at least one residual hand mail item that is fed by the infeed conveyor. The guide element can also serve as a stop element, for example, to fix the predefined position on the distribution conveyor. If the distribution conveyor is then activated, the piece goods can be guided along the guide element until they leave the distribution conveyor and are fed to the discharge conveyor. This can ensure that the residual hand mail item is safely transferred from the distribution conveyor to the discharge conveyor.

Optionally, the distribution conveyor is inclined relative to the first direction. Whereas the second direction can run parallel to the distribution conveyor.

Optionally, the infeed conveyor has at least one pivotable conveyor module, wherein the at least one conveyor module can be designed to either convey the residual hand mail item to the distribution conveyor or to convey it further onto the infeed conveyor. The at least one pivotable conveyor module can be an element that can actively transfer a residual hand mail item from the infeed conveyor to the distribution conveyor. This makes it possible to actively control which residual hand mail item is placed on which distribution conveyor (if, for example, a large number of distribution conveyors are provided). The conveyor module can realize the ejection of at least one residual hand mail item.

Optionally, the infeed conveyor has at least one pivotable conveyor module, wherein the pivotable conveyor module can be pivoted about a pivot axis. The pivot axis is optionally orthogonal to the first direction. As a result, the residual hand mail items to be discharged can be discharged either upwards or downwards (relative to the direction of gravity) from the infeed conveyor. As a result, it is possible to eject certain residual hand mail items during ongoing conveyor operation of the infeed conveyor, in particular without influencing (e.g. stopping) the transportation of other residual hand mail items.

Optionally, the conveyor module is pivotable between a first position and a second position, wherein in the first position the conveyor module may be arranged in a first plane, and wherein in the second position the conveyor module may be inclined relative to the first plane. In other words, in the first position, the conveyor module can form part of the infeed conveyor. If the conveyor module is therefore in the first position, a continuous conveyor section of the infeed conveyor can be realized, so that a residual hand mail item can easily pass over the conveyor module and can continue to be transported in the first direction. In the second position, on the other hand, the conveyor module can be inclined so that a residual hand mail item is moved or deflected away from the first direction and transported in a different direction.

In the second position, the conveyor module is optionally inclined at an angle of 15° to 24°, preferably approximately 19°, relative to the horizontal. In the range of 15° to 24°, it has been shown that even if the conveyor module is inclined downwards relative to the direction of gravity, the residual hand mail items continue to rest on the conveyor module and can therefore be fed to the distribution conveyor without any problems. If the inclination is steeper, it is possible that residual hand mail items lose contact with the conveyor module, which can cause the residual hand mail items to roll or roll over, which in turn can lead to damage to the residual hand mail items. With the inclination of approximately 19°, it has been found that the residual hand mail items can be conveyed quickly to the distribution conveyor so that the conveyor module can be quickly returned to the first position so that the infeed conveyor can continue to convey residual hand mail items. This enables rapid cycling of the residual hand mail items onto the infeed conveyor.

Optionally, the second position is dependent on the residual hand mail item. In other words, the second position can be variable, depending on the residual hand mail item. More specifically, the conveyor module may be pivoted (i.e. moved to the second position) as a function of the residual hand mail item. Optionally, the conveyor module is pivoted as a function of at least one dimension of the residual hand mail item. For example, the conveyor module can be pivoted by approx. 19° (i.e. relative to the first position) when the height of the residual hand mail item is approx. 150 mm. In contrast, the conveyor module can optionally be pivoted by approx. 10° at a height of the residual hand mail item. This can ensure that the conveyor module is only pivoted by the necessary pivoting angle. In other words, it is not necessary to pivot the conveyor module further than is required to convey the residual hand mail item. In this way, the cycle time of the handled residual hand mail items can be increased. Furthermore, the conveyor module can be pivoted depending on the weight of the residual hand mail item. In this way, a downward slope force acting on the residual hand mail item can be set precisely. Furthermore, a position of the residual hand mail item on the input conveyor and/or a dimension of the residual hand mail item can be determined (e.g. recognized) when a residual hand mail item is placed on the input conveyor. The pivot angle of the conveyor module can be selected according to the residual hand mail item to be ejected using the information on the dimensions of the residual hand mail item (e.g. residual hand mail item height or item height). As a result, the gap between the residual hand mail items required for the pivot process can be selected smaller for residual hand mail items with a lower item height, which enables higher system throughputs. Furthermore, flatter (i.e. smaller) conveyor module pivot angles make it easier to stack residual hand mail items on the distribution conveyor.

Optionally, the output conveyor has at least a first conveyor section and a second conveyor section, wherein the first conveyor section is arranged upstream in the conveying direction and is inclined relative to the second conveyor section. In other words, the first conveyor section can be inclined relative to the second direction. In contrast, the first conveyor section can run parallel to the first direction. Optionally, the first conveyor section is inclined in such a way that a residual hand mail item applied to the output conveyor must be conveyed in the opposite direction to the direction of gravity. This has the advantage that a residual hand mail item that is placed on the output conveyor and rests on another residual hand mail item can slide back until it itself comes into contact with the surface of the output conveyor. This can ensure that the sorting sequence is maintained, even if many residual hand mail items are placed on the output conveyor one after the other. It has been found that an inclination of approximately 4° of the first conveyor section relative to the horizontal one is sufficient to achieve this effect. The surface of the output conveyor can have a higher roughness than the surface of the residual hand mail items. This can improve the adhesion of the residual hand mail items on the output conveyor.

Optionally, the first conveyor section and the second conveyor section can be driven in synchronization with each other. This can also ensure uniform transportation on the second conveyor section, which is arranged downstream of the first conveyor section in the second direction.

Optionally, the residual hand sorting device has at least one sensor that is designed to detect whether or not a residual hand mail item exceeds a collection arrangement limit and to output measurement information. The sensor can, for example, be realized as a light barrier. For example, the sensor is arranged in such a way that it can check a residual hand mail item being transported on the conveyor section with regard to the collection arrangement limit. Furthermore, the sensor can be arranged directly downstream in the second direction from the point where a residual hand mail item is transferred from the distribution conveyor to the output conveyor. If the sensor detects that a collection arrangement limit has been exceeded by a residual hand mail item, i.e. in particular that the mail item is too large in the gravity direction, the output conveyor can be controlled in such a way that a subsequent residual hand mail item is not applied to the previously conveyed residual hand mail item (i.e. the residual hand mail item that exceeds the collection arrangement limit). In other words, the previously applied residual hand mail item can be handled as a single mail item. This ensures that the residual hand mail items do not pile up excessively on the output conveyor, which could lead to instability. In other words, the control unit can be designed to control the output conveyor and/or the distribution conveyor based on the measurement information.

Optionally, the control unit is designed to drive the output conveyor in steps. In other words, after a residual hand mail item hits the output conveyor, the output conveyor can be driven or moved one step further until the next residual hand mail item hits it. In other words, the output conveyor can be driven step by step rather than continuously. This can ensure that the collection arrangement can always be implemented satisfactorily, even when the supply of residual hand mail items is slow.

Optionally, the output conveyor has an interface via which a user can activate and/or deactivate continuous conveyor operation of the output conveyor. In other words, a user can have a collection arrangement of residual hand mail items located on the output conveyor actively transported to one end of the output conveyor. This is advantageous, for example, if a user is about to empty an output conveyor and actuates the interface, for example in the form of a switch, in order to have all the residual hand mail items transported to the end of the output conveyor. In this way, all or some of the residual hand mail items on the output conveyor can be transported to one end of the output conveyor and removed there by the user or transferred to containers provided.

Optionally, the output conveyor can include a sensor at one end of the output conveyor that can detect whether there is a residual hand mail item at the end of the output conveyor. This can signal that the output conveyor is completely full and could be emptied next. This offers the advantage that a user is actively notified when an output conveyor is full so that the user can empty it. Furthermore, it is possible to prevent the further feeding of residual hand mail items to this output conveyor.

Optionally, the output conveyor is designed to feed residual hand mail items present in the collection arrangement to a container and/or for manual removal. In other words, the output conveyor can have an output section at its end, at which residual hand mail items can be transferred for further processing. For example, the output conveyor can be tilted in sections so that the residual hand mail items can be output from the output conveyor.

Optionally, the infeed conveyor has at least one input conveyor which is designed to pick up residual hand mail items and place them on the infeed conveyor. The at least one input conveyor can be a conveying element that is independent of the infeed conveyor. The input conveyor can be a belt conveyor, ball conveyor, roller conveyor or the like. The input conveyor can be designed so that a user can place residual hand mail items on it in order to feed them to the automated residual hand sorting system. The input conveyor can be designed to feed residual hand mail items onto the infeed conveyor. The infeed conveyor can be designed to transport at least one residual hand mail item to the infeed conveyor.

Optionally, the control unit is designed to control the at least one input conveyor in such a way that the residual hand mail item is conveyed to the input conveyor at suitable points in a conveyor stream. In other words, the infeed of residual hand mail items by the infeed conveyor can also be automated. The advantage of this is that the distance between the residual hand mail items and the infeed conveyor already has a predetermined dimension, so that further processing, in particular transfer to distribution conveyors, can be carried out easily and automatically.

Optionally, the at least one input conveyor is arranged in a fourth plane, wherein the fourth plane is inclined relative to the first plane. Optionally, the fourth plane is arranged above the first plane in the direction of gravity. This means that a residual hand mail item, which is fed onto the infeed conveyor by the input conveyor, can be transported using gravity. This is conveyed in particular by the inclination of the input conveyor relative to the first plane.

Optionally, the at least one input conveyor is inclined in a range of 15° to 21°, optionally of about 18°, relative to the horizontal. In the range of 15° to 21°, it has been found that the inclination is optimal for maintaining static friction between a residual hand mail item and the surface of the input conveyor, so that a residual hand mail item that is manually positioned on the input conveyor remains there and does not accidentally fall onto the infeed conveyor. The inclination of approximately 18° has proven to be advantageous for a wide range of residual hand mail items.

Optionally, the input conveyor has at least one sensor, in particular a camera, which can be designed to obtain and output information about the residual hand mail item. In particular, the sensor can be designed to obtain a dimension of the residual hand mail item deposited on the input conveyor. Furthermore, the sensor can be designed to obtain information about the destination of the residual hand mail item. Based on this, a destination (e.g. a specific output conveyor) can be determined to which the residual hand mail item is to be fed. Optionally, the sensor is designed as a camera that can simultaneously detect a dimension of the residual hand mail item and the address of the residual hand mail item. The camera can be arranged vertically above the input conveyor. However, this presupposes that the residual hand mail item is placed on the input conveyor with the address label facing upwards (i.e. towards the camera). Furthermore, it is also conceivable that a six-sided camera system can be provided, so that the positioning of the residual hand mail item on the input conveyor is irrelevant, as the address label can be recognized in any orientation of the residual hand mail item.

Optionally, the control unit is configured to control the at least one input conveyor based on information about the residual hand mail item in order to realize an infeed onto the infeed conveyor. In other words, the control unit can be designed to recognize a gap on the infeed conveyor that matches the residual hand mail item located on the input conveyor so that it can be fed into the gap on the infeed conveyor. This determination can be made individually for the respective residual hand mail item and can depend on the dimensions of the residual hand mail item. Furthermore, the control unit can be designed to drive the input conveyor faster or slower, depending on whether a gap between two adjacent residual hand mail items on the infeed conveyor is small or large. By driving the input conveyor quickly, even a small gap can be utilized by a residual hand mail item. If a gap is larger, the input conveyor can also be driven more slowly to save energy. This enables individual and adapted operation of the residual hand sorting device.

Optionally, the infeed conveyor has a labeling device that is designed to provide at least one residual hand mail item with a label. The labeling of the residual hand mail items may be required for a further (e.g. manual) sorting process. Optionally, the label is applied after an address of the residual hand mail item has been read. Labeling can be realized, for example, by affixing an individually created sticker.

Optionally, the labeling device is designed to apply the label to the residual hand product during transport on the infeed conveyor, in particular without having to reduce the transport speed of the infeed conveyor. In other words, an actuator system can be provided which can apply the label to the residual hand mail item on the infeed conveyor during normal transportation. As a result, it is not necessary to slow down or even interrupt the transport of the residual hand mail item, so that the process is not affected by the labeling of the residual hand mail items.

Optionally, the first direction and the second direction are aligned transversely to each other, in particular orthogonally to each other, in a plan view. As a result, a compact residual hand sorting device can be provided overall.

A large number of distribution conveyors and a large number of output conveyors are optionally provided. This enables a high sorting depth to be achieved for the residual hand mail items. Optionally, the infeed conveyor has a large number of conveyor modules arranged one behind the other in the first direction. In this way, residual hand mail items can be discharged at many points on the infeed conveyor. As a result, a large number of distribution conveyors can be fed with residual hand mail items, which can increase the sorting depth.

Optionally, a distribution conveyor and at least one output conveyor are assigned to each conveyor module. Optionally, the at least one output conveyor is designed as an end point. In other words, each output conveyor can be defined as a destination for a specific class of residual hand mail items.

According to a further aspect of the present disclosure, a method for sorting residual hand mail items is provided. The method may comprise feeding a residual hand mail item from an infeed conveyor onto an output conveyor, such that the residual hand mail item is arranged in a collection arrangement on the output conveyor. Furthermore, the method may comprise transporting the residual hand mail item on the output conveyor in the collection arrangement. Optionally, the method may comprise receiving at least one piece of information about the residual hand mail item, wherein the feeding of the residual hand mail item from an infeed conveyor to an output conveyor may be based on the at least one piece of information about the residual hand mail item. Optionally, prior to feeding a residual hand mail item from an infeed conveyor to an output conveyor, the residual hand mail item is fed onto the infeed conveyor, in particular based on the at least one piece of information about the residual hand mail item.

According to one aspect of the present disclosure, one or more operating forces apply a residual hand mail item to input conveyors which are arranged above the infeed conveyor. A camera is located above each of the input conveyors, which recognizes the residual hand mail item and records an image of the residual hand mail item or the address. The image and the tracking information of the residual hand mail item are transmitted to the control unit and the residual hand mail item can be fed onto the horizontal infeed conveyor. If there is a gap on the infeed conveyor, the residual hand mail item is accelerated and deposited on the infeed conveyor from above. The insertion of the residual hand mail item, i.e. the start time and the size of the required gap on the infeed conveyor, depends on the position and dimensions of the residual hand mail item. Both are transmitted to the control unit by means of a suitable camera. After the residual hand mail item has been fed in, it is transported to the labeling device. The transport route to the labeling device is dimensioned in such a way that the read result (i.e. the information obtained by the camera) of the residual hand mail item is available and the residual hand mail item can be labeled. The labeling of the residual hand mail item can be carried out by one or more labeling devices, which can be robot-assisted, realized by linear axes or other suitable actuators. Optionally, the labeling is carried out by a robot arm from above during the normal transport of the residual hand mail item. The labels are required for the subsequent (manual) sorting process. Once the residual hand mail item has been labeled, the residual hand mail item is ejected at the corresponding sorting point by the downward-pivoting conveyor module and positioned on a distribution conveyor arranged transverse to the conveying direction (i.e. the first direction). The distribution conveyor is inclined for better positioning of the residual hand mail item. After the positioning of the residual hand mail item on the distribution conveyor has been completed, the distribution conveyor accelerates the residual hand mail item transversely to the first direction and deposits it on one or more output conveyors. The output conveyor is controlled in such a way that it continues to cycle only briefly for each deposited item in accordance with the desired collection arrangement. There can be several output conveyors per output conveyor (depending on the system layout). The first conveyor section of the output conveyor is arranged at an angle to prevent a residual hand mail item from slipping on a residual hand mail item that has already been deposited. All output conveyors run synchronously, i.e. they start/stop/cycle together. The output conveyor can be started using a foot switch on the output conveyor. The residual hand mail items, which are provided in the collection arrangement, are thus transported for manual removal or in a suitable container. The gap that this creates interrupts the collection arrangement of the residual hand mail items and a new collection arrangement of residual hand mail items is formed. Above a certain thickness of residual hand mail items, the residual hand mail items can no longer be arranged in the collection arrangement (e.g. shoe boxes). This collection arrangement limit is checked by means of an adjustable light barrier during shipment transport before labeling. If residual hand mail items are too thick, the light barrier responds and the residual hand mail item is treated as an individual item in the respective output conveyor, i.e. the output conveyors interrupt the collection arrangement and cycle to such an extent that they can pick up residual hand mail items that cannot be arranged in the collection arrangement as individual items.

According to a further aspect of the present disclosure, a use of the residual hand device according to one of the above embodiments in a sorting process of residual hand mail items is provided.

### BRIEF DESCRIPTION OF THE DRAWINGS

Individual features of embodiments can be combined with other features or other embodiments to form new embodiments. Advantages and embodiments mentioned in connection with the individual features or embodiments also apply analogously to the new embodiments. Advantages and embodiments explained in connection with the device also apply analogously to the method and vice versa.

In the following, preferred embodiments are described in detail with reference to the attached figures.

FIG. 1 is a schematic and perspective view of a residual hand sorting device according to one embodiment of the present disclosure;

FIG. 2 is a schematic and perspective view of a part of a residual hand sorting device according to an embodiment of the present disclosure;

FIG. 3 is a schematic and perspective view of a part of a residual hand sorting device according to an embodiment of the present disclosure;

FIG. 4 is a schematic and perspective view of a part of a residual hand sorting device according to an embodiment of the present disclosure;

FIG. 5 is a schematic and perspective view of a residual hand sorting device according to a further embodiment of the present disclosure; and

FIG. 6 is a schematic and perspective view of a residual hand sorting device according to an embodiment of the present disclosure.

### DETAILED DESCRIPTION OF THE PREFERRED EMBODIMENTS

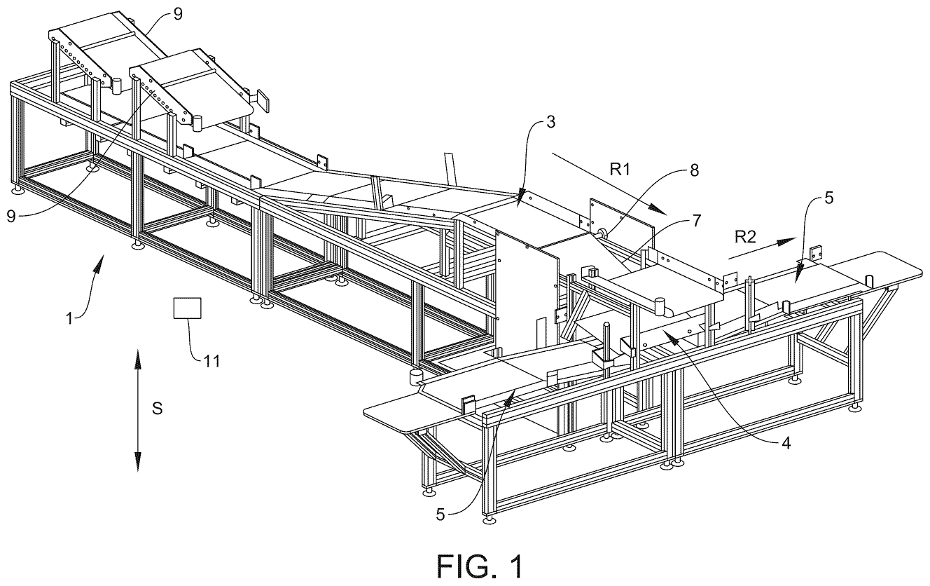

FIG. 1 is a schematic and perspective view of a residual hand sorting device 1 for sorting residual hand mail items 2. The residual hand sorting device 1 comprises an infeed conveyor 3, a distribution conveyor 4 and, in the present embodiment, two output conveyors 5. The infeed conveyor 3 can transport residual hand mail items 2 in a first direction R1. The residual hand mail item 2 can then be fed to the distribution conveyor 4 by a pivoting conveyor module 7. The pivotable conveyor module 7 can be pivoted about a pivot axis 8. From the distribution conveyor 4, the mail item can be fed either to the first output conveyor 5 or to the opposite second output conveyor 5. Furthermore, in the present embodiment, the infeed conveyor 3 has two input conveyors 9. The input conveyors 9 are designed to pick up residual hand mail items and feed them to the infeed conveyor 3.

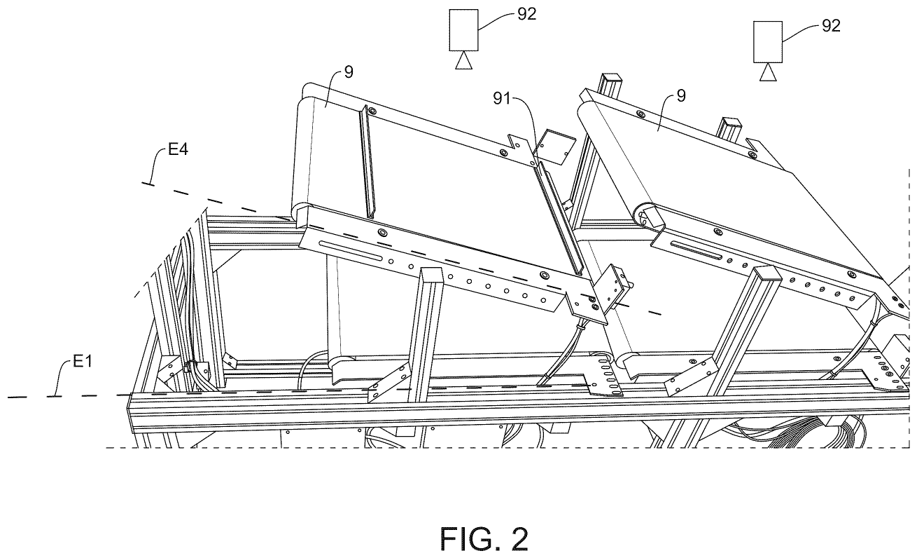

FIG. 2 is a schematic and perspective view of a part of the sorting device according to an embodiment of the present disclosure. More specifically, FIG. 2 shows in detail the two input conveyors 9 of the sorting device 1 shown in FIG. 1. In the present embodiment, the input conveyors 9 are located in a fourth plane which is inclined relative to the first plane. The input conveyors 9 of the present embodiment are realized as belt conveyors. Furthermore, the input conveyor has ribs 91 which can ensure the safe transportation of a residual hand mail item. A camera 92 is also shown schematically, which is provided above each input conveyor 9. The camera can pick up the residual hand mail item which is placed on the input conveyor 9, in order to record the dimensions and/or the address of the residual hand mail item.

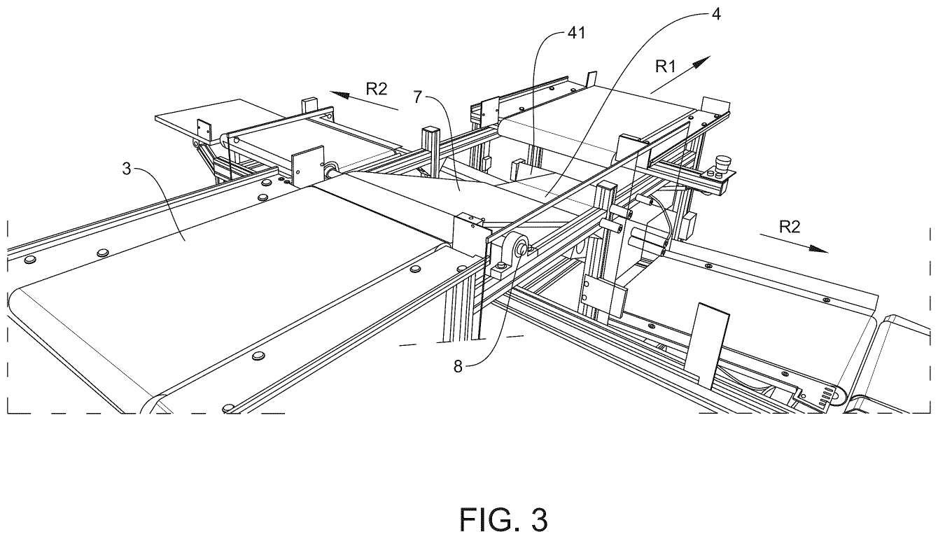

FIG. 3 is a schematic and perspective view of the sorting device 1 according to the embodiment shown in FIG. 1. More precisely, a part of the infeed conveyor 3 is shown in FIG. 3. The conveyor module 7 is also visible. In the embodiment shown in FIG. 3, the conveyor module is in the second position. In other words, a residual hand mail item transported on the infeed conveyor 3 can be fed to the underlying distribution conveyor 4 via the conveyor module 7. The conveyor module 7 can be pivoted about a pivot axis 8. When the conveyor module 7 is in the first position, it forms a flat surface with the remaining conveyor surface of the infeed conveyor 3 and can transport residual hand mail items further in the first direction.

The guide element 41 of the distribution conveyor 4 can also be seen in FIG. 3. If a residual hand mail item is fed to the distribution conveyor 4 via the conveyor module 7, the residual hand mail item collides with the guide element 41. This ensures predefined positioning of the residual hand mail item on the distribution conveyor 4.

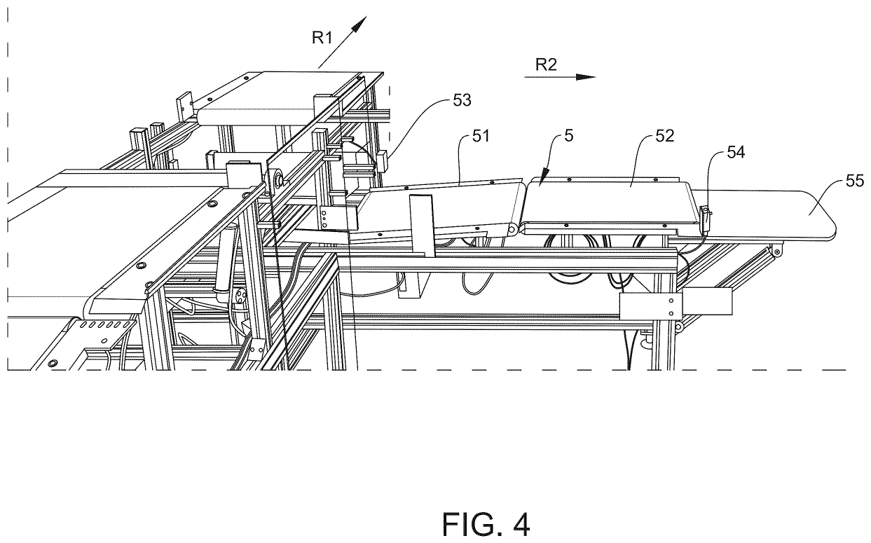

FIG. 4 is a schematic and perspective view of a part of the residual hand sorting device 1 according to the embodiments shown in FIG. 1. More specifically, the output conveyor 5 is shown in FIG. 4. The output conveyor 5 has a first conveyor section 51 and a second conveyor section 52. The first conveyor section 51 is inclined relative to the second conveyor section 52. In other words, residual hand mail items that are applied to the output conveyor must be conveyed on the first conveyor section against the force of gravity. Furthermore, the output conveyor 5 has a first sensor 53 and a second sensor 54. In the present embodiment, the sensors 53, 54 are designed as light barriers. The first conveyor 53 can check whether the collection arrangement 6 is formed correctly. The second sensor 54 can output a signal when the output conveyor 5 is full. Downstream of the output conveyor 5, a removal 55 is recognizable, at which a user can remove the collection arrangement of residual hand mail items.

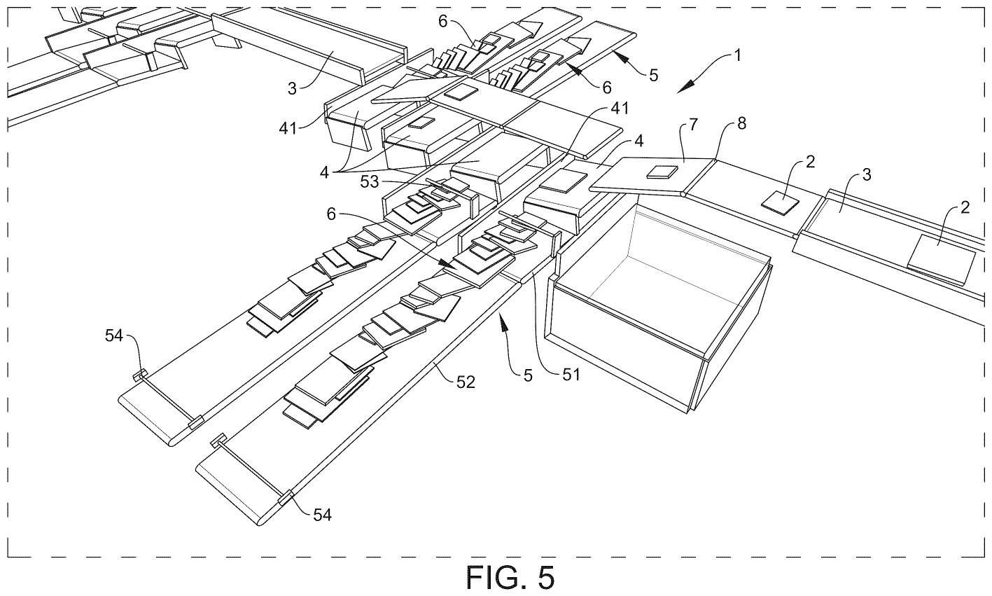

FIG. 5 is a schematic and perspective view of a sorting device 1 according to a further embodiment of the present disclosure. The sorting device 1 of the present embodiment differs from the embodiment described above in that a plurality of conveyor modules 7 connected in series are provided, each of which is assigned a distribution conveyor 4. Each distribution conveyor is in turn assigned an output conveyor 5. The individual features of the individual devices correspond to the embodiment described above. Thus, a plurality of distribution conveyors 4 connected in series can be provided in order to further increase the sorting depth. Furthermore, a collection arrangement 6 is shown in FIG. 5, in which residual hand mail items are transported in a collection arrangement on the output conveyor 5.

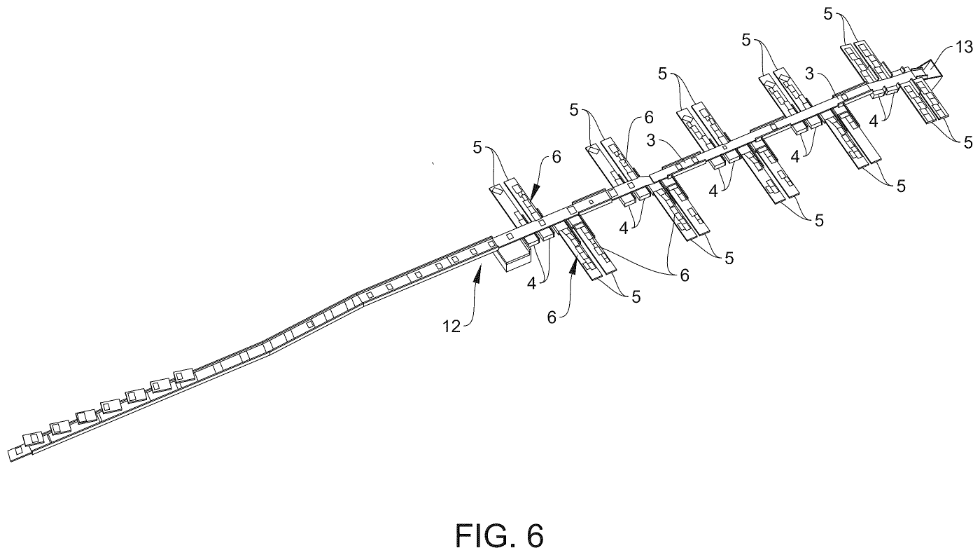

FIG. 6 is a schematic and perspective view of a sorting device 1 according to a further embodiment of the present disclosure. The sorting device 1 of the present embodiment essentially corresponds to the previous embodiment, with the difference that the labeling device 12 is now also recognizable. Furthermore, a plurality of input conveyors 9 are provided, which feed the residual hand mail items 2 onto the feed conveyor 3. A label is then attached to the labeling device on the residual hand mail item and transported onwards to the respective output conveyors 5. A collection container 13 is located at the very end of the infeed conveyor 3, into which, for example, residual hand mail items that require manual handling can be deposited.

### LIST OF REFERENCE SYMBOLS

1 Residual hand sorting device
2 Residual hand mail items
3 Infeed conveyor
4 Distribution conveyor
5 Output conveyor
6 Collection arrangement
7 Conveyor module
8 Pivot axis
9 Input conveyor
11 Control unit
12 Labeling device
13 Container
51 First conveyor section
52 Second conveyor section
53 First sensor
54 Second sensor
55 Issue
91 Rib
92 Camera
41 Sliding element

1. A residual hand sorting device for sorting residual hand mail items, comprising:
an infeed conveyor configured to convey at least one residual hand mail item in a first direction;
at least one distribution conveyor configured to take over the at least one residual hand mail item from the infeed conveyor and to convey it to at least one output conveyor; and
a control unit configured to control the distribution conveyor and/or the output conveyor such that residual hand mail items are collected on the output conveyor in a collection arrangement;
wherein the output conveyor is configured to convey the collection arrangement of residual hand mail items in a second direction.

2. The residual hand sorting device according to claim 1, wherein at least two residual hand mail items at least partially overlap in the collecting arrangement.

3. The residual hand sorting device according to claim 2, wherein the control unit is configured to control the distribution conveyor and/or the output conveyor based on at least one piece of information about the at least one residual hand mail item in such a way that the residual hand mail item is arranged on the output conveyor in the collection arrangement.

4. The residual hand sorting device according to claim 3, wherein the distribution conveyor is inclined with respect to the infeed conveyor and/or the outlet conveyor.

5. The residual hand sorting device according to claim 4, wherein the infeed conveyor comprises at least one pivotable conveyor module configured to convey the residual hand mail item either to the distribution conveyor or to convey it further on the infeed conveyor.

6. The residual hand sorting device according to claim 5, wherein the output conveyor comprises at least a first conveyor section and a second conveyor section, wherein the first conveyor section is arranged upstream in the conveying direction and is inclined relative to the second conveyor section.

7. The residual hand sorting device according to claim 6, wherein the residual hand sorting device has at least one sensor configured to detect whether or not a residual hand mail item exceeds a collection arrangement limit and to output measurement information.

8. The residual hand sorting device according to claim 7, wherein the control unit is configured to control the output conveyor based on the measurement information.

9. The residual hand sorting device according to claim 8, wherein the infeed conveyor has at least one input conveyor configured to receive residual hand mail items and to place them on the infeed conveyor.

10. The residual hand sorting device according to claim 1, wherein the control unit is configured to control the distribution conveyor and/or the output conveyor based on at least one piece of information about the at least one residual hand mail item in such a way that the residual hand mail item is arranged on the output conveyor in the collection arrangement.

11. The residual hand sorting device according to claim 1, wherein the distribution conveyor is inclined with respect to the infeed conveyor and/or the outlet conveyor.

12. The residual hand sorting device according to claim 1, wherein the infeed conveyor comprises at least one pivotable conveyor module configured to convey the residual hand mail item either to the distribution conveyor or to convey it further on the infeed conveyor.

13. The residual hand sorting device according to claim 1, wherein the output conveyor comprises at least a first conveyor section and a second conveyor section, wherein the first conveyor section is arranged upstream in the conveying direction and is inclined relative to the second conveyor section.

14. The residual hand sorting device according to claim 1, wherein the residual hand sorting device has at least one sensor configured to detect whether or not a residual hand mail item exceeds a collection arrangement limit and to output measurement information.

15. The residual hand sorting device according to claim 14, wherein the control unit is configured to control the output conveyor based on the measurement information.

16. The residual hand sorting device according to claim 1, wherein the infeed conveyor has at least one input conveyor configured to receive residual hand mail items and to place them on the infeed conveyor.

17. A method for sorting residual hand mail items, comprising:
feeding a residual hand mail item from an infeed conveyor to an output conveyor so that the residual hand mail item is arranged in a collecting arrangement on the output conveyor;
transporting the residual hand mail item on the output conveyor in the collection arrangement.
